(19) United States
(12) Patent Application Publication
(10) Pub. No.: US 2014/0203649 A1
(43) Pub. Date: Jul. 24, 2014

(54) Method and Apparatus for Integrating a Secondary Power Source into a Power Generation Plant

(71) Applicants: Christopher Michael Cheek, Concord, MA (US); Peter James Faill, Groton, MA (US); Michael Jay Datta, Somerville, MA (US)

(72) Inventors: Christopher Michael Cheek, Concord, MA (US); Peter James Faill, Groton, MA (US); Michael Jay Datta, Somerville, MA (US)

(73) Assignee: 3L POWER LLC, Waltham, MA (US)

(21) Appl. No.: 14/107,413

(22) Filed: Dec. 16, 2013

Related U.S. Application Data
(60) Provisional application No. 61/754,465, filed on Jan. 18, 2013.

(51) Int. Cl. H02J 9/06

(52) U.S. Cl. CPC H02J 9/06; H02J 9/066
USPC 307/66; 307/64; 307/68

(57) ABSTRACT

A plant secondary power source consists of an auxiliary power source, an auxiliary converter, and a connection to a power generation plant DC voltage link. The auxiliary power source provides power control functionality without the use of direct communication between the auxiliary power system and the power generation plant.

### CROSS-REFERENCES TO RELATED APPLICATIONS

This application claims priority to provisional patent application 61754465.

### BACKGROUND

Renewable energy sources such as solar and wind are inherently intermittent due to their dependency on weather conditions which are uncontrollable and not easily predictable. This intermittency is the main detriment to the adoption of renewables. For example, solar energy harvested during the day may or may not align with consumer energy demands of that day. In fact, peak energy demand is often offset in time from peak solar generation. Likewise, wind energy harvested during the night may or may not align with consumer energy demands during that time period. As a result, such energy sources cannot act as a base energy source.

Renewable energy sources are often used as supplemental energy sources on grids, which have base line energy generated from traditional sources such as coal or gas. As penetration of renewable energy on the grid increases to a more substantial percentage of total energy generation, significant problems arise. For example, if during peak energy consumption sudden weather conditions cause renewables to rapidly cease energy generation, a cascading effect may cause larger plants to drop out as well resulting in black-outs and economic loss. For these reasons, newer utility regulations are beginning to demand controlled ramp rates from renewable power plants often leading them to install back up generators, which burn fossil fuels.

In order to mitigate some of the effects of intermittency as well as maximize plant profits, photovoltaic power plants are often oversized and underutilized. For example, a photovoltaic power plant certified for a 1 MW grid connection to the utility may actually consist of 1.25 MW of photovoltaic panels. The plant is typically oversized so that on average days it is able to deliver its allotted 1 MW. However, on above average days, although the plant is capable of producing 1.25 MW, the plant inverter must be power curtailed to 1 MW. The extra 250 kW of power is simply wasted. Considering that each utility scale solar installation must perform such a power curtailment on an above average day the result is a large underutilization of existing resources.

As the cost, efficiency, and capacity of new battery technologies improve they hold promise for storing energy from renewable sources to make them less intermittent. Existing state of the art systems fall into two categories. In the first category are small scale energy storage/inverter systems, also known as “multi-port inverters” which are typically low in efficiency, require low battery and system voltages, and cannot easily integrate into renewable energy power plants. In the second category are large blocks of batteries accompanied by modified utility scale inverters, which although are often co-located with renewables they are unable store energy directly from renewables or interact with renewables.

The invention disclosed herein solves the need for an energy storage system, which cost-effectively integrates into new and existing renewable energy plants, better utilizing their resources and making them less intermittent to the grid.

### BRIEF SUMMARY OF INVENTION

Various embodiments of the invention include an auxiliary power source and power converter with a connection to the varying or constant DC voltage link of a power generating plant. The auxiliary power system of the present invention can connect to a power generation plant and provide desirable power smoothing, shaping, and ramp rate limiting functionality without direct communications with the power generation plant and without adversely affecting the power generation plant.

### BRIEF DESCRIPTION OF THE DRAWINGS

FIG. 1 is a schematic view of an embodiment of the auxiliary power system of the present invention connected to a grid-connected power generation plant.

FIG. 2 is a schematic view of a battery and DC/DC converter embodiment of the present invention connected to a photovoltaic power generation plant.

FIG. 3 is a diagram that shows various feedback and operating parameters and how they contribute to auxiliary converter control according to an embodiment of the invention control method.

### DETAILED DESCRIPTION

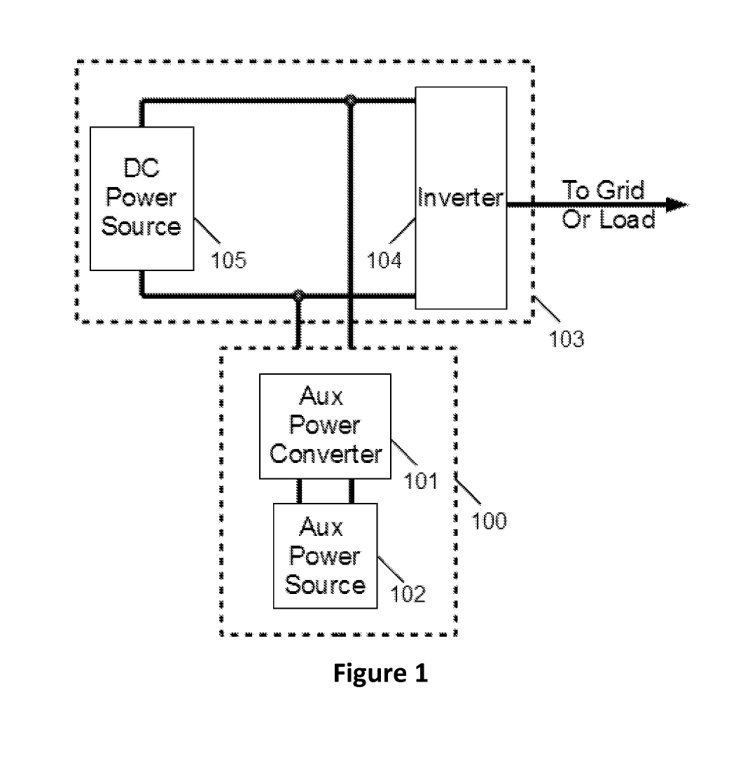

FIG. 1 illustrates one embodiment of the present invention 100. According to the invention, a power converter 101 is utilized to connect an auxiliary power supply/source/storage element 102 to a power generation system 103, such as a solar or wind plant. The auxiliary power supply/source 102 can consist of any device capable of storing and/or delivering energy, such as an electric battery, diesel generator, or flywheel system. The power converter 101 can be any electric power converter capable of converting power from the auxiliary supply 102 into DC voltage for use by the generation plant's inverter 104. The power generation system 103 can consist of any power generation means that utilizes a voltage-source inverter to deliver power from a DC power source 105 to the AC grid or any local AC load. The generation plant's DC power source 105 can consist of any native DC power source, such as with photovoltaic arrays, or any rectified AC source, such as with a rectified wind turbine generator or rectified gas turbine generator. Any of the three major components of the auxiliary power supply 102, the power converter 101, or the power generation system 103 may consist either singly or as a plurality of such components or systems. The present invention covers the auxiliary power source 102 and auxiliary power converter 101 and the control methodology that allows the auxiliary system to connect to and function with a new or existing power generation plant.

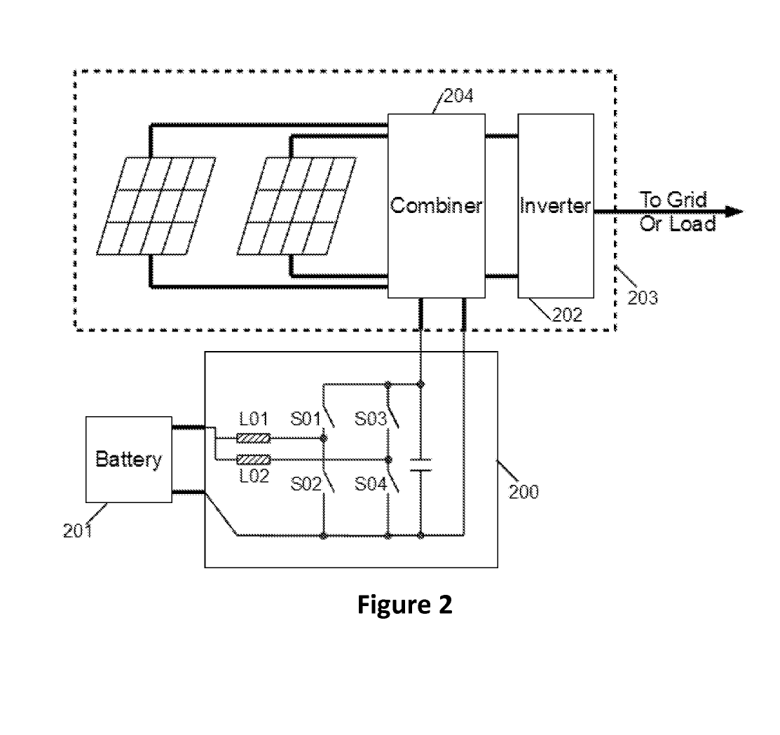

In one embodiment, the power converter of the present invention is a multi-leg DC/DC converter that connects an electric battery to the DC link of a photovoltaic (PV) inverter, as illustrated in FIG. 2. The DC/DC converter 200 boosts the battery 201 voltage by operating switches S02 and S04 to deliver power to the generation plant inverter 202 when necessary and bucks inverter voltage by operating switches S01 and S02 when recharging the battery 201. The DC/DC converter 200 can perform this bidirectional power conversion function either as an original part of the solar plant design, or as a retrofit. The DC/DC converter 200 can also perform its conversion function according to a schedule or command and without direct communication with the inverter 202 or PV generating plant 203.

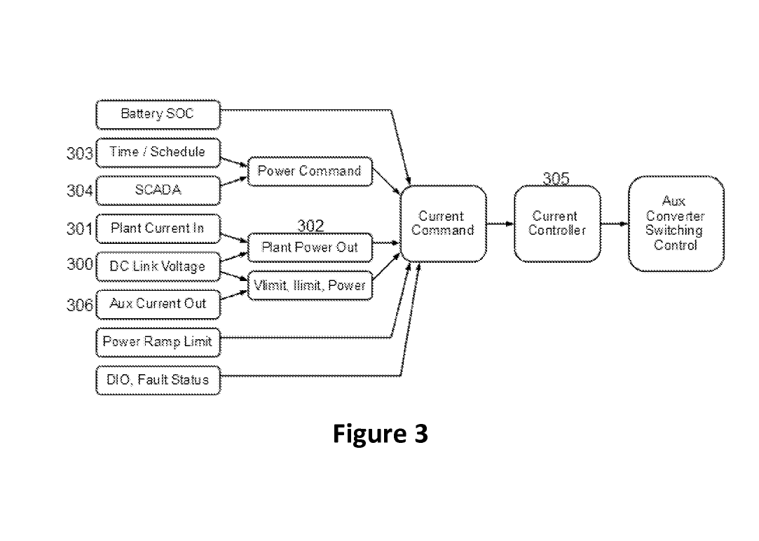

A PV or wind power generating facility typically operates under voltage and current conditions that optimize power output from the plant. Prior art requires that the generating facility and any auxiliary power system be integrated such that the auxiliary power system does not interfere with the generating facility's maximum power point tracking MPPT functionality. The power converter of the present invention could perform its conversion functions without direct communication with the generating facility and without interfering with the generating facility's MPPT functionality, anti-islanding functionality, or other functionality, per the methodology outlined in FIG. 3. During normal operation, the converter runs in a mode that does not interfere with common MPPT algorithms, such as in constant power mode. Most MPPT algorithms have very low controls bandwidth, and the high controls bandwidth of the auxiliary power converter can easily allow the auxiliary power source to appear as a constant power source or load to the generating plant to avoid interference with the MPPT. The converter can be configured to ramp up or down in power at either very slow or very fast constant rates to attain constant power level targets, again to avoid interfering with the generating plant's controller.

While in power ramp limit mode, the converter of the present invention uses its internal voltage feedback measurement 300 and the feedback from an external current probe 301 to determine generating plant output power 302. The external current probe can utilize any DC current measurement technology or mounting technique (such as with a clamp-on hall-effect probe), and can be retrofitted on an existing inverter's DC link or in any DC junction box, combiner box 204 or any other point at which full or some subset of generating plant current can be measured. The probe need not touch inverter hardware, nor interface with the inverter in any other way other than to observe/measure magnetic field or other effects evident from the inverter's DC current consumption. Probe feedback 301 can be calibrated during install through parameters used by the auxiliary converter's controller. The generating plant's power output slew rate can be limited by the auxiliary power supply without any intentional power rate limiting function in the generating plant, by feeding or sinking the generating plant current and/or voltage at a rate and in proportions that are tunable to each generating plant by auxiliary converter controller parameters.

In another separate or simultaneous embodiment, the auxiliary converter 101 can cause the generating plant to appear to the grid to be a constant power source or a predictable power source whose output with time follows a prescribed curve, despite the installed generating plant's controller only being programmed to maximize power output through its MPPT. In this operating mode, total plant output power could follow a time-shifted curve 303 to more closely match day-time load peaks as well as absorb extra renewable energy that exceeds the generating plant inverter's power/current ratings. The generating plant can supply power to the grid using a typical MPPT algorithm, but total plant power output can be controlled by the present invention's auxiliary power converter through power injection that does not interfere with the generating plant inverter's functionality. In one method embodiment, for example, the auxiliary converter would supply and sink power as needed to match the intermittent generating plant's power output to the scheduled 303 or commanded 304 power output. The auxiliary converter can provide the needed power output difference without interfering with the generating plant's functional goal of providing maximum power by injecting or sinking power from the inverter's DC link in a manner that does not affect at least one of the inverter's MPPT parameters within the bandwidth of the MPPT controller. In one illustrative embodiment of this method, the auxiliary controller injects or sinks millisecond-scale constant current from the generating plant's inverter using a fast current control loop 305 with auxiliary current feedback 306, further controlled by a slower outer power control loop that reaches system power output goals with a speed that is slightly slower than the generating system's MPPT bandwidth. Hardware current and voltage limitations for both the generating plant and auxiliary converter and source are adhered to by setting current and voltage limit parameters in the auxiliary converter's controller.

In another embodiment of the present invention, the generating system includes one or more DC/DC converters in-between the generating power source and the generating plant's grid-connected inverter such that the inverter runs at a constant DC link voltage during normal non-curtailed operation, and the MPPT functionality resides in the single or plural DC/DC converters. In this type of system configuration, the DC link voltage is usually controlled by the inverter, and the auxiliary converter of the present invention can be configured to always run in a current control mode to meet all of its competing performance goals.

Common and often competing performance goals for the auxiliary power converter of the present invention include, but are not limited to, the ability to control system power, power ramp rates, battery state of charge, AC frequency support, grid backup, microgrid functionality, utilization of excess generating plant capacity, and other ancillary functionality. The preferred set of embodiments of the present invention include an auxiliary power converter that allows for additional power control, utilization and firming functionality to be easily retrofitted to existing intermittent power generation plants, without the need for complicated communications pathways and without detrimentally affecting existing power generation plant functionality, safety, performance, or reliability.

What is claimed is:

1. An apparatus comprising
an auxiliary power supply capable of delivering and/or storing energy;
a power conversion system which is able to control the energy stored in and/or delivered from the aforementioned power supply; and
a connection between the aforementioned power conversion system and a greater energy generation plant, without direct communications.

2. The apparatus of claim 1, wherein the auxiliary power supply comprises at least one of the following: a battery, a flywheel, a supercapacitor, or a generator.

3. The apparatus of claim 1, wherein the power conversion system comprises a bidirectional DC-DC converter.

4. The apparatus of claim 1, wherein the connection is made to a photovoltaic power plant or wind turbine power plant.

5. The apparatus of claim 1, wherein the connection is made to the constant or varying DC link of the greater energy generation plant.

6. The apparatus of claim 1, wherein any one or multiples of one of the auxiliary power supply, auxiliary converter, generation plant DC source, or generation plant inverter consists of a plurality of such components

7. A method for controlling the apparatus such that there is no direct communication with the aforementioned greater energy generation plant, the method comprising:
predetermining a desired time-based power output behavior of the greater energy generation plant either per schedule input or by processing real-time power commands;
determining the voltage at the interconnection between the apparatus and the energy generation plant;
determining the current between the power generation plant's DC source and the greater energy plant inverter; and
controlling power generation plant output by controlling power to and from the auxiliary converter apparatus based on the aforementioned voltage and/or current and/or predetermined power output behavior.

8. The method of claim 7, wherein the DC plant current measurement consists of a hall-effect current probe that relays information to the auxiliary power converter controller.
